(19) United States
(12) Patent Application Publication
(10) Pub. No.: US 2024/0145159 A1
(43) Pub. Date: May 2, 2024

(54) COIL COMPONENT

(71) Applicant: SAMSUNG ELECTRO-MECHANICS CO., LTD., Suwon-si (KR)

(72) Inventors: Byeong Cheol MOON, Suwon-si (KR); Han LEE, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/375,270

(22) Filed: Sep. 29, 2023

(30) Foreign Application Priority Data
Nov. 1, 2022 (KR) 10-2022-0143684

(51) Int. Cl. H01F 27/28; H01F 27/00; H01F 27/29

(52) U.S. Cl. CPC H01F 27/2852; H01F 27/006; H01F 27/29

(57) ABSTRACT

A coil component includes: a body; first and second support members disposed in the body; first and second coils disposed on the first support member; first and second vias connecting the first and second coils; third and fourth coils disposed on the second support member; and third and fourth vias connecting the third and fourth coils, wherein each innermost turn of the first and second coils has a parallel connection section between a point connected to the first via and a point connected to the second via, each innermost turn of the third and fourth coils has a parallel connection section between a point connected to the third via and a point connected to the fourth via, and a line width of each innermost turn of the first to fourth coils in the parallel connection section is smaller than a line width of each adjacent outer turn.

### CROSS-REFERENCE TO RELATED APPLICATION(S)

This application claims benefit of priority to Korean Patent Application No. 10-2022-0143684 filed on Nov. 1, 2022 in the Korean Intellectual Property Office, the disclosure of which is incorporated herein by reference in its entirety.

### BACKGROUND

### 1. Technical Field

The present disclosure relates to a coil component.

### 2. Description of Related Art

An inductor, one of coil components, is a representative passive electronic component used in an electronic device together with a resistor and a capacitor.

As electronic devices gradually become more sophisticated and miniaturized, the number of electronic components used in electronic devices is also increased and their sizes are miniaturized.

Meanwhile, there is a demand for a structure with a larger area of a central core and a low direct current (DC) resistance R_{dc} for the component to have an improved inductance characteristic even in a limited size due to miniaturization thereof. In particular, a coupled inductor in which two or more coils magnetically coupled to each other in one part are disposed may have higher utility when using the above structure.

### SUMMARY

An aspect of the present disclosure may provide a coil component with improved inductance characteristic and saturation current (Iₛₐₜ) characteristic by having a line width of an innermost turn made thinner to secure a larger area of a central core of a coil.

Another aspect of the present disclosure may provide a coil component in which a direct current (DC) resistance R_{dc} may be maintained even with a reduced line width of an innermost turn.

Another aspect of the present disclosure may provide a coil component with an improved inductance characteristic by mitigating misalignment of a magnetic path formed between two coils magnetically coupled to each other in a coupled inductor.

According to an aspect of the present disclosure, a coil component may include: a body; first and second support members disposed in the body; first and second coils disposed on both surfaces of the first support member and respectively having at least one turn; first and second vias connecting innermost turns of the first and second coils to each other; third and fourth coils disposed on both surfaces of the second support member and respectively having at least one turn; third and fourth vias connecting innermost turns of the third and fourth coils to each other; and first to fourth external electrodes disposed on the body and respectively connected to the first to fourth coils, wherein each innermost turn of the first and second coils has a parallel connection section formed between a point connected to the first via and a point connected to the second via, each innermost turn of the third and fourth coils has a parallel connection section formed between a point connected to the third via and a point connected to the fourth via, and a line width of each innermost turn of the first to fourth coils in the parallel connection section is smaller than a line width of each adjacent outer turn.

According to an aspect of the present disclosure, a coil component may include: a body; first and second support members disposed in the body; first and second coils disposed on both surfaces of the first support member and respectively having at least one turn; first and second vias connecting innermost turns of the first and second coils to each other; third and fourth coils disposed on both surfaces of the second support member and respectively having at least one turn; third and fourth vias connecting innermost turns of the third and fourth coils to each other; and first to fourth external electrodes disposed on the body and respectively connected to the first to fourth coils, wherein each innermost turn of the first and second coils has a parallel connection section between a point connected to the first via and a point connected to the second via, and at least one of first and second coils includes at least a portion of an outermost turn and at least a portion of the innermost turn both overlapping at least one of the first and second external electrodes along a thickness direction of the coil component.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view schematically illustrating a coil component according to a first exemplary embodiment of the present disclosure;

FIG. 2 is an assembled perspective view illustrating a connection relationship between a coil and a support member;

FIG. 3 is a plan view of FIG. 1 in direction A;

FIG. 4 is a view illustrating each of first to fourth coils of FIG. 1;

FIG. 5 is a view illustrating a cross-section taken along line I-I′ in FIG. 1;

FIG. 6 is a view illustrating a cross-section taken along line II-II′ in FIG. 1;

FIG. 7 is a view illustrating a cross-section taken along line III-III′ in FIG. 1;

FIG. 8 is a view schematically illustrating an L-T cross-section of a coil component according to a second exemplary embodiment of the present disclosure, and is a view corresponding to FIG. 5;

FIG. 9 is a view schematically illustrating an L-T cross-section of a coil component according to a third exemplary embodiment of the present disclosure, and is a view corresponding to FIG. 6; and

FIG. 10 is a plan view of a comparative example, and is a view corresponding to FIG. 3.

### DETAILED DESCRIPTION

Hereinafter, exemplary embodiments of the present disclosure will now be described in detail with reference to the accompanying drawings.

In the drawings, an L direction refers to a first direction or length direction, a W direction refers to a second direction or width direction, and a T direction refers to a third direction or thickness direction.

Hereinafter, a coil component according to exemplary embodiments of the present disclosure will be described in detail with reference to the accompanying drawings. In describing the exemplary embodiments of the present disclosure with reference to the accompanying drawings, components that are the same as or correspond to each other will be denoted by the same reference numerals, and an overlapping description thereof will be omitted.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter, or the like.

### First Exemplary Embodiment

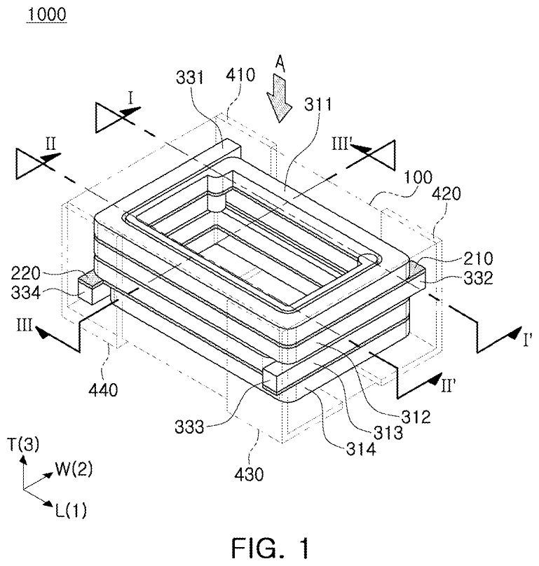

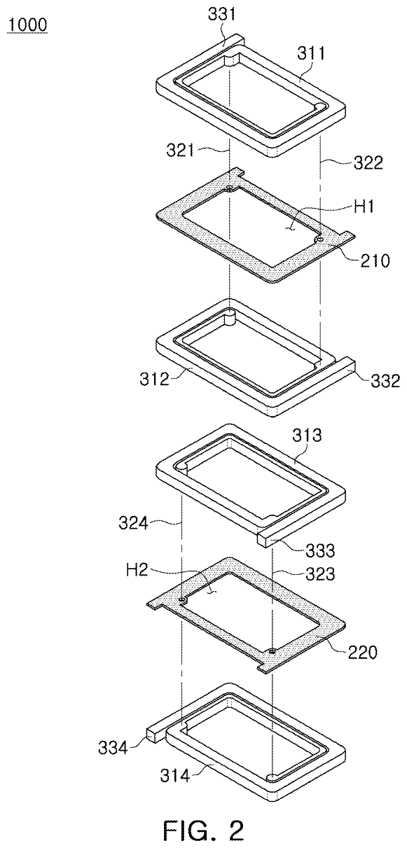

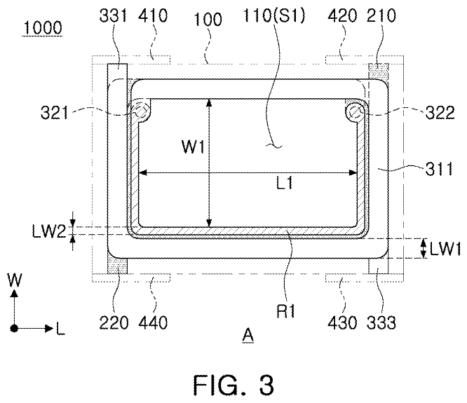

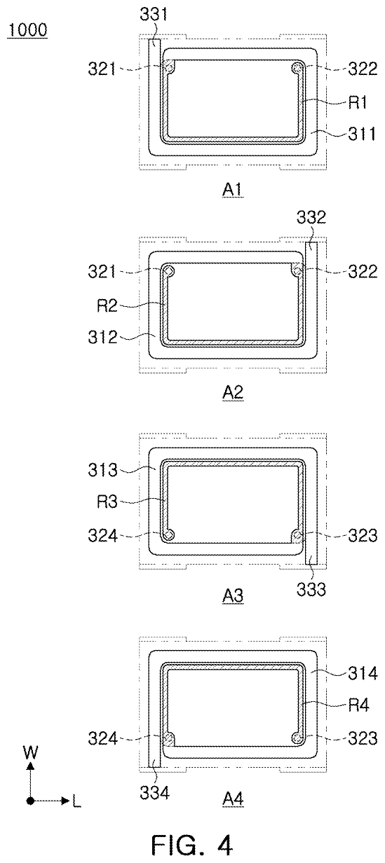

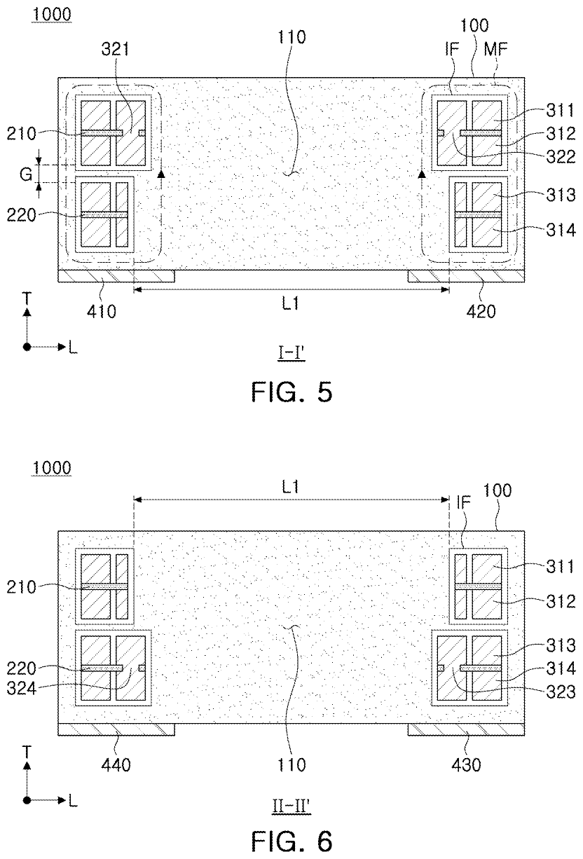

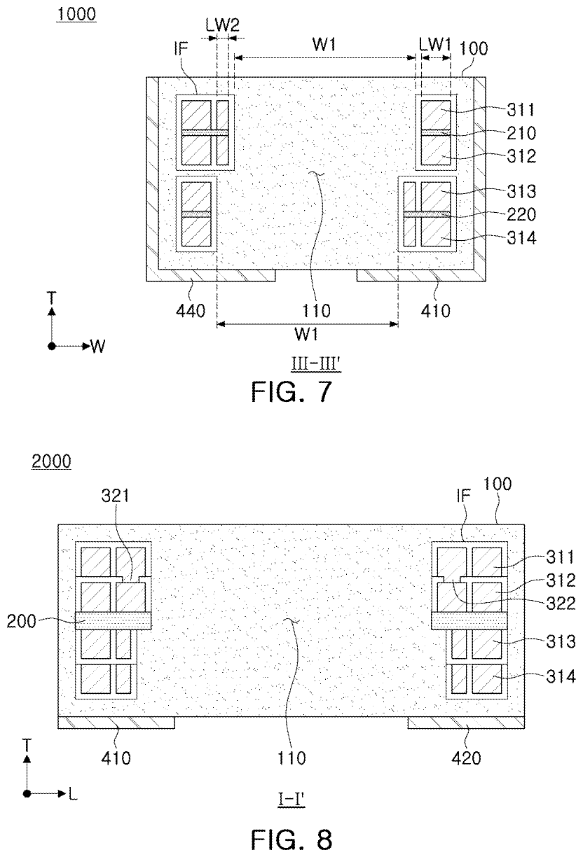

FIG. 1 is a perspective view schematically illustrating a coil component 1000 according to a first exemplary embodiment of the present disclosure; FIG. 2 is an assembled perspective view illustrating a connection relationship between coils 311, 312, 313, and 314 and support members 210 and 220; FIG. 3 is a plan view of FIG. 1 in a direction A; FIG. 4 is a view illustrating each of first to fourth coils of FIG. 1; FIG. 5 is a view illustrating a cross-section taken along line I-I′ of FIG. 1; FIG. 6 is a view illustrating a cross-section taken along line II-II′ of FIG. 1; and FIG. 7 is a view illustrating a cross-section taken along line III-III′ of FIG. 1.

Meanwhile, the drawings omit an insulating layer disposed on a body 100 that is applied to this exemplary embodiment to more clearly show coupling between components.

Referring to FIGS. 1 through 7, the coil component 1000 according to a first exemplary embodiment of the present disclosure may include the body 100, the first and second support members 210 and 220, the first to fourth coils 311, 312, 313, and 314, first to fourth vias 321, 322, 323, and 324, and first to fourth external electrodes 410, 420, 430, and 440.

The coil component 1000 according to this exemplary embodiment may include the first to fourth coils 311, 312, 313, and 314 disposed in the body 100. Here, the first and second coils 311 and 312 may function as one coil part, the third and fourth coils 313 and 314 may function as another coil part, and the two coil parts may be magnetically coupled to each other.

Here, a parallel connection section may be formed between the first coil 311 and the second coil 312 through the first and second vias 321 and 322, and a parallel connection section may be formed between the third coil 313 and the fourth coil 314 through the third and fourth vias 323 and 324.

Here, a core 110 may have a larger area by having a line width LW2 of the parallel connection section made smaller than a line width LW1 of the other section. In this way, the coil component may have a direct current (DC) resistance R_{dc} maintained without being increased due to an effect of the parallel connection while having improved inductance characteristic and saturation current (Iₛₐₜ) characteristic.

It is also possible to shorten a path of a magnetic flux formed between the first and second coils 311 and 312 and the third and fourth coils 313 and 314 coupled to each other, thus making it easier to adjust a coupling coefficient k.

Hereinafter, the description specifically describes the main components included in the coil component 1000 according to this exemplary embodiment.

The body 100 may form an appearance of the coil component 1000 according to this exemplary embodiment, and embed first and second support members 210 and 220, and the first to fourth coils 311, 312, 313, and 314.

The body 100 may generally have a hexahedral shape.

The body 100 may have a first surface and a second surface opposing each other in the length (L) direction or first direction, a third surface and a fourth surface opposing each other in the width (W) direction or second direction, and a fifth surface and the sixth surface opposing each other in the thickness (T) direction or third direction. Each of the first to fourth surfaces of the body 100 may correspond to a wall surface of the body 100 that connects the fifth and sixth surfaces of the body 100 to each other. Hereinafter, both end surfaces of the body 100 may indicate the first and second surfaces of the body 100, both side surfaces of the body 100 may indicate the third and fourth surfaces of the body 100, one surface of the body 100 may indicate the sixth surface of the body 100, and the other surface of the body 100 may indicate the fifth surface of the body 100.

For example, the body 100 may be formed for the coil component 1000 according to this exemplary embodiment including the external electrodes 410, 420, 430, and 440 described below to have: a length of 2.5 mm, a width of 2.0 mm, and a thickness of 1.0 mm; a length of 2.0 mm, a width of 1.2 mm, and a thickness of 0.65 mm; a length of 1.6 mm, a width of 0.8 mm, and a thickness of 0.8 mm; a length of 1.0 mm, a width of 0.5 mm, and a thickness of 0.8 mm; or a length of 0.8 mm, a width of 0.4 mm, and a thickness of 0.65 mm. However, the present disclosure is not limited thereto. Meanwhile, the above exemplary dimensions for the length, width, and thickness of the coil component 1000 may be dimensions that do not reflect process errors, and a range of the dimensions recognized to include the process errors may thus fall within that of the above-described exemplary dimensions.

The above length of the coil component 1000 may indicate the maximum value of respective dimensions of a plurality of line segments spaced apart from each other in the thickness (T) direction, and connecting two outermost boundary lines opposing each other in the length (L) direction of the coil component 1000 shown in the following image to be parallel to the length (L) direction, based on the optical microscope image or scanning electron microscope (SEM) image of a cross-section of the coil component 1000 in a length (L)-thickness (T) direction that is taken from its center in the width (W) direction. Other methods and/or tools appreciated by one of ordinary skill in the art, even if not described in the present disclosure, may also be used. Alternatively, the length of the coil component 1000 may indicate the minimum value of the respective dimensions of the plurality of line segments described above. Alternatively, the length of the coil component 1000 may indicate an arithmetic average value of at least three of the respective dimensions of the plurality of line segments described above. Here, the plurality of line segments parallel to the length (L) direction may be equally spaced from each other in the thickness (T) direction, and the scope of the present disclosure is not limited thereto.

The above thickness of the coil component 1000 may indicate the maximum value of respective dimensions of a plurality of line segments spaced apart from each other in the length (L) direction, and connecting two outermost boundary lines opposing each other in the thickness (T) direction of the coil component 1000 shown in the following image to be parallel to the thickness (T) direction, based on the optical microscope image or scanning electron microscope (SEM) image of the cross-section of the coil component 1000 in the length (L)-thickness (T) direction that is taken from its center in the width (W) direction. Alternatively, the thickness of the coil component 1000 may indicate the minimum value of the respective dimensions of the plurality of line segments described above. Other methods and/or tools appreciated by one of ordinary skill in the art, even if not described in the present disclosure, may also be used. Alternatively, the thickness of the coil component 1000 may indicate an arithmetic average value of at least three of the respective dimensions of the plurality of line segments described above. Here, the plurality of line segments parallel to the thickness (T) direction may be equally spaced from each other in the length (L) direction, and the scope of the present disclosure is not limited thereto.

The above width of the coil component 1000 may indicate the maximum value of respective dimensions of a plurality of line segments spaced apart from each other in the length (L) direction, and connecting two outermost boundary lines opposing each other in the width (W) direction of the coil component 1000 shown in the following image to be parallel to the width (W) direction, based on the optical microscope image or scanning electron microscope (SEM) image of a cross-section of the coil component 1000 in a length (L)-width (W) direction that is taken from its center in the thickness (T) direction. Alternatively, the width of the coil component 1000 may indicate the minimum value of the respective dimensions of the plurality of line segments described above. Other methods and/or tools appreciated by one of ordinary skill in the art, even if not described in the present disclosure, may also be used. Alternatively, the width of the coil component 1000 may indicate an arithmetic average value of at least three of the respective dimensions of the plurality of line segments described above. Here, the plurality of line segments parallel to the width (W) direction may be equally spaced from each other in the length (L) direction, and the scope of the present disclosure is not limited thereto.

Alternatively, each of the length, width and thickness of the coil component 1000 may be measured using a micrometer measurement method. The micrometer measurement method may be used by setting a zero point with a micrometer using a repeatability and reproducibility (Gage R&R), inserting the coil component 1000 according to this exemplary embodiment between tips of the micrometer, and turning a measurement lever of the micrometer. Meanwhile, when measuring the length of the coil component 1000 by using the micrometer measurement method, the length of the coil component 1000 may indicate a value measured once or an arithmetic average of values measured several times. This method may be equally applied to measure the width or thickness of the coil component 1000.

The body 100 may include a magnetic material and resin. In detail, the body 100 may be formed by laminating one or more magnetic composite sheets in which the magnetic material is dispersed in the resin. However, the body 100 may also have a structure other than the structure in which the magnetic material is dispersed in the resin. For example, the body 100 may be made of a magnetic material such as ferrite or a non-magnetic material.

The magnetic material may be the ferrite or metal magnetic powder particles.

The ferrite may be, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite, a hexagonal type ferrite such as Ba—Zn-based ferrite, Ba—Mg-based ferrite, Ba—Ni-based ferrite, Ba—Co-based ferrite or Ba—Ni—Co-based ferrite, a garnet type ferrite such as Y-based ferrite, and Li-based ferrite.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powder particles may be one or more of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles.

The metal magnetic powder particles may be amorphous or crystalline. For example, the metal magnetic powder particles may be Fe—Si—B—Cr-based amorphous alloy powder particles, and are not necessarily limited thereto.

The ferrite and the metal magnetic powder particles may respectively have average diameters of about 0.1 μm to 30 μm, and are not limited thereto.

The body 100 may include two or more types of magnetic materials dispersed in the resin. Here, different types of magnetic materials may indicate that the magnetic materials dispersed in the resin are distinguished from each other by any one of an average diameter, a composition, crystallinity, and a shape.

The resin may include epoxy, polyimide, liquid crystal polymer (LCP), or the like, or mixtures thereof, and is not limited thereto.

The body 100 may have the core 110 passing through the first and second support members 210 and 220 and the first to fourth coils 311, 312, 313, and 314 described below.

Referring to FIGS. 2 and 5, a first through-hole H1 may be disposed in a central region of the first support member 210, and a second through-hole H2 may be disposed in a central region of the second support member 220.

The first and second coils 311 and 312 are disposed on both surfaces of the first support member 210, the third and fourth coils 313 and 314 may be disposed on both surfaces of the second support member 220, and the core 110 may be formed by a magnetic composite sheet filling the first and second through-holes H1 and H2 respectively formed in the first and second support members 210 and 220.

Through this structure, the first to fourth coils 311, 312, 313, and 314 may share one core 110.

The first and second support members 210 and 220 may be disposed in the body 100. The first and second support members 210 and 220 are components supporting the first to fourth coils 311, 312, 313 and 314 described below.

In detail, the first support member 210 may support the first and second coils 311 and 312 disposed on both surfaces thereof, and the second support member 220 may support the third and fourth coils 313 and 314 disposed on both surfaces thereof.

Meanwhile, the first and second support members 210 and 220 may be excluded in some exemplary embodiments, such as a case where the coil 311, 312, 313, or 314 corresponds to a wound coil or has a coreless structure.

The first or second support member 210 or 220 may be made of an insulating material including thermosetting insulating resin such as epoxy resin, thermoplastic insulating resin such as polyimide, or photosensitive insulating resin, or may be made of an insulating material having a reinforcement material such as a glass fiber or an inorganic filler impregnated in the insulating resin. For example, the support member 210 or 220 may be made of a material such as prepreg, an Ajinomoto Build-up Film (ABF), FR-4, bismaleimide triazine (BT) resin, a photo imagable dielectric (PID) or a copper clad laminate (CCL), and is not limited thereto.

The inorganic filler may use one or more materials selected from the group consisting of silica (or silicon dioxide, SiO₂), alumina (or aluminum oxide, Al₂O₃), silicon carbide (SiC), barium sulfate (BaSO₄), talc, clay, mica powder particles, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

Here, when made of the insulating material including the reinforcing material, first or second support member 210 or 220 may have more excellent rigidity. The first or second support member 210 or 220 may be made of the insulating material including no glass fiber. In this case, an entire thickness of the first and second support members 210 and 220 and the first to fourth coils 311, 312, 313 and 314 (indicating sum of the respective dimensions of the first to fourth coils 311, 312, 313 and 314 and the first and second support members 210 and 220 in the thickness (T) direction of FIG. 1) may be thinned, which is advantageous in reducing a thickness of the component. The first or second support member 210 or 220 may be made of the insulating material including the photosensitive insulating resin. In this case, the number of processes for forming the first to fourth coils 311, 312, 313 and 314 may be reduced, which is advantageous in reducing a production cost, and the fine first to fourth vias 321, 322, 323, and 324 may also be formed. For example, the first or second support member 210 or 220 may have a thickness of 10 μm or more or 50 μm or less, and is not limited thereto.

Referring to FIGS. 1 and 2, the first to fourth coils 311, 312, 313, and 314 may be disposed on the first and second support members 210 and 220. The first and second coils 311 and 312 may be disposed on both the surfaces of the first support member 210, and the third and fourth coils 313 and 314 may be disposed on both the surfaces of the second support member 220.

Meanwhile, in this exemplary embodiment, the magnetic material included in the body 100 may be charged while no support member is disposed between the second and third coils 312 and 313, and the present disclosure is not limited thereto.

The first to fourth coils 311, 312, 313, and 314 may be embedded in the body 100 to express a characteristic of the coil component. For example, when the coil component 1000 of this exemplary embodiment is used as the power inductor, the first to fourth coils 311, 312, 313, and 314 may store an electric field as a magnetic field to maintain an output voltage, thereby stabilizing power of the electronic device.

In particular, in a coupled inductor having four terminals as in this exemplary embodiment, when power is applied thereto, the first and second coils 311 and 312 and the third and fourth coils 313 and 314 may be designed to be magnetically coupled to each other to have the desired coupling coefficient k.

Referring to FIGS. 1 through 6, each of the first to fourth coils 311, 312, 313, and 314 may have at least one turn, and have a planar square spiral shape in which the turns are wound around the core 110 of the body 100. However, the scope of the present disclosure is not limited thereto, and each of the first to fourth coils 311, 312, 313, and 314 may have a circular or elliptical planar spiral shape as needed.

The first and second coils 311 and 312 may be connected to each other through the first and second vias 321 and 322, and the third and fourth coils 313 and 314 may be connected to each other through the third and fourth vias 323 and 324.

For example, the first coil 311 may be disposed on an upper surface of the first support member 210 based on directions shown in FIG. 1, and have two or more turns wound around the core 110. The second coil 312 may be disposed on a lower surface of the first support member 210, and have at least two or more turns wound around the core 110.

The third coil 313 may be disposed on an upper surface of the second support member 220, and have two or more turns wound around the core 110. The fourth coil 314 may be disposed on a lower surface of the second support member 220, and have at least two or more turns wound around the core 110.

Referring to FIGS. 1 and 2, the first to fourth coils 311, 312, 313, and 314 may respectively include first to fourth lead portions 331, 332, 333, and 334 at each end of their outermost turns. Here, the first and second lead portions 331 and 332 may extend to one side surface (or third surface) of the body 100, and the third and fourth lead portions 333 and 334 may extend to the other side surface (or fourth surface) of the body 100. Here, one side surface (or third surface) and the other side surface (or fourth surface) of the body 100 may indicate two surfaces of the body that oppose each other in the width (W) direction.

The innermost turns of the first and second coils 311 and 312 may be connected to each other through the conductive first and second vias 321 and 322, and the outermost turns of the first and second coils 311 and 312 may respectively be connected to the first and second external electrodes 410 and 420 described below through the first and second lead portions 331 and 332.

In addition, the innermost turns of the third and fourth coils 313 and 314 may be connected to each other through the conductive third and fourth vias 323 and 324, and the outermost turns of the third and fourth coils 313 and 314 may respectively be connected to the third and fourth external electrodes 430 and 440 described below through the third and fourth lead portions 333 and 334.

In a thin-film inductor, the first and second coils 311 and 312, or the third and fourth coils 313 and 314 may be generally connected to each other through one via.

However, the first and second coils 311 and 312 in this exemplary embodiment may be connected to each other at two points through the first and second vias 321 and 322, thus having the parallel connection section formed between the first and second vias 321 and 322. In addition, the third and fourth coils 313 and 314 may be connected to each other at two points through the third and fourth vias 323 and 324, thus having the parallel connection section formed between the third and fourth vias 323 and 324.

In detail, each innermost turn of the first and second coils 311 and 312 may have the parallel connection section formed between a point connected to the first via 321 and a point connected to the second via 322, and each innermost turn of the third and fourth coils 313 and 314 may have parallel connection section formed between a point connected to the third via 323 and a point connected to the fourth via 324.

Referring to FIGS. 3 and 4, the first coil 311 may have a parallel connection section R1 from the point where the innermost turn is connected to the first via 321 to the point where the innermost turn is connected to the second via 322. The second coil 312 may also have a parallel connection section R2 in the same way, and the parallel connection section R1 of the first coil 311 and the parallel connection section R2 of the second coil 312 may overlap each other when projected in the thickness (T) direction.

In addition, the third coil 313 may have a parallel connection section R3 from a point where the innermost turn is connected to the third via 323 to a point where the innermost turn is connected to the fourth via 324. The fourth coil 314 may also have a parallel connection section R4 in the same way, and the parallel connection section R3 of the third coil 313 and the parallel connection section R4 of the fourth coil 314 may overlap each other when projected in the thickness (T) direction.

In this way, an equivalent resistance of a circuit may be reduced by providing the parallel connection section between the coils 311, 312, 313, and 314, which may lower the R_{dc} of the coil component 1000 to thus increase its power efficiency.

Referring to FIGS. 1 through 7, a partial region of each innermost turn of the first to fourth coils 311, 312, 313, and 314 may have a smaller line width.

In detail, referring to FIGS. 3 and 4, the line width LW2 of each innermost turn of the first to fourth coils 311, 312, 313, and 314 in the above-described parallel connection sections R1, R2, R3 and R4 may be smaller than the line width LW1 of each adjacent outer turn.

The line width LW2 of each innermost turn of the first to fourth coils 311, 312, 313, and 314 in the parallel connection sections R1, R2, R3 and R4 may be half or less of the line width LW1 of each adjacent outer turn. For example, when the line width LW1 of the adjacent outer turn is 150 μm, the line width LW2 of each innermost turn of the first to fourth coils 311, 312, 313, and 314 in the parallel connection sections R1, R2, R3 and R4 may be 75 μm or less, and the present disclosure is not limited thereto.

In this way, the core 110 may have the larger area by having the smaller line width LW2 of each innermost turn of the first to fourth coils 311, 312, 313, and 314 in the partial region, thereby improving the inductance characteristic and saturation current (I sat) characteristic of the coil component.

Here, the line width of each of the first to fourth coils 311, 312, 313, and 314 may indicate an arithmetic average value of at least three of respective dimensions of a plurality of line segments spaced apart from each other in the length (L) direction, and connecting two outermost boundary lines opposing each other in the width (W) direction of each of the first to fourth coils 311, 312, 313, and 314 shown in the following image to be parallel to the width (W) direction, based on the optical microscope image or scanning electron microscope (SEM) image of a cross-section of each of the first to fourth coils 311, 312, 313, and 314 in the length (L)-width (W) direction that is taken from its center in the thickness (T) direction. Here, the plurality of line segments parallel to the width (W) direction may be equally spaced from each other in the length (L) direction, and the scope of the present disclosure is not limited thereto. Other methods and/or tools appreciated by one of ordinary skill in the art, even if not described in the present disclosure, may also be used.

In detail, referring to FIGS. 3 and 4, the line width LW2 of each innermost turn of the first to fourth coils 311, 312, 313, and 314 in the above-described parallel connection sections R1, R2, R3 and R4 may be smaller than a line width of each innermost turn in the other sections except for the parallel connection section.

That is, among the innermost turns of the first to fourth coils 311, 312, 313, and 314, each innermost turn in the other sections except for the parallel connection sections R1, R2, R3, and R4 may have a line width substantially the same as the line width LW1 of the adjacent outer turn, and thus have a larger line width than the line width in each of the parallel connection sections R1, R2, R3, and R4. Here, being substantially the same indicates being the same, including the process error, a position deviation, or a measurement error that occurs in a manufacturing process.

Summarizing the above descriptions, the line width LW2 of each innermost turn of the first to fourth coils 311, 312, 313, and 314 may be made smaller to secure the area of the core 110. Accordingly, the R_{dc} may be lower by the parallel connection sections R1, R2, R3, and R4 formed through the plurality of vias even though an side effect of R_{dc} increase occurs, thereby suppressing the R_{dc} increase in the coil component 1000.

That is, the coil component 1000 according to this exemplary embodiment may have the R_{dc} which is maintained without being increased while securing the improved inductance characteristic, by the larger area of the core 110.

Referring to FIGS. 1 through 4, each of the first to fourth coils 311, 312, 313, and 314 may have a shape of a square spiral wound parallel to the surface of the body 100.

The coil may generally have the circular or elliptical planar spiral structure. However, in this exemplary embodiment, each of the first to fourth coils 311, 312, 313, and 314 may be parallel to each of the wall surfaces (or the first to fourth surfaces) of the body 100, that is, to have a substantially constant gap with the wall surface.

Through this structure, the core 110 may secure a larger area than when each of the first to fourth coils 311, 312, 313, and 314 has the circular or elliptical planar spiral structure.

Referring to FIG. 3, L1 indicates a length (or L-direction dimension) of the core 110, W1 indicates a width (or W-direction dimension) of the core 110, and S1 indicates the area of the core 110. Here, L1, W1, and S1 may be increased as the line width LW2 of the innermost turn of the first coil 311 in the parallel connection section R1 is made smaller than the line width LW1 of the other sections.

Referring to FIGS. 2 through 4, each of the first to fourth vias 321, 322, 323, and 324 may be connected to one corner region of each innermost turn of the first to fourth coils 311, 312, 313, and 314.

In detail, one corner region of the innermost turn of the first coil 311 may be connected to the first via 321, and its inner end may be connected to the second via 322. In addition, one corner region of the innermost turn of the second coil 312 may be connected to the second via 322, and its inner end may be connected to the first via 321.

Similarly, one corner region of the innermost turn of the third coil 313 may be connected to the third via 323, and its inner end may be connected to the fourth via 324. In addition, one corner region of the innermost turn of the fourth coil 314 may be connected to the fourth via 324, and its inner end may be connected to the third via 323.

As described above, when each of the first to fourth coils 311, 312, 313, and 314 have the square spiral shape, each of the first to fourth vias 321, 322, 323, and 324 may be connected to one corner region of each innermost turn of the first to fourth coils 311, 312, 313, and 314. In this case, a region area of a via pad for improving connection reliability between the via and the coil may be made smaller than a case where the via is connected to a straight region of the innermost turn of the coil, thus securing a larger effective volume as much as the area made smaller.

Referring to FIGS. 5 and 6, the first and second vias 321 and 322 may pass through the first support member 210 to connect the innermost turns of the first and second coils 311 and 312 to each other, and the third and fourth vias 323 and 324 may pass through the second support member 220 to connect the innermost turns of the third and fourth coils 313 and 314 to each other.

Each diameter of the first to fourth vias 321, 322, 323, and 324 may be greater than the line width LW2 of each innermost turn of the first to fourth coils 311, 312, 313, and 314 in the parallel connection sections R1, R2, R3, and R4. However, the present disclosure is not limited thereto.

Referring to FIGS. 1 through 4, ends of the outermost turns of the first to fourth coils 311, 312, 313, and 314 may respectively include first to fourth lead portions 331, 332, 333, and 334.

The first to fourth lead portions 331, 332, 333, and 334 may respectively extend to the surface of the body 100 and be connected to the first to fourth external electrodes 410, 420, 430, and 440 described below.

In detail, the first and second lead portions 331 and 332 may extend to one side surface (or third surface) of the body 100 while being spaced apart from each other, and the third and fourth lead portions 333 and 334 may extend to the other side surface (or fourth surface) of the body 100 while being spaced apart from each other.

That is, the first and second coils 311 and 312 physically connected to each other may be led out to one side surface of the body 100 to be spaced apart from each other, and the third and fourth coils 313 and 314 physically connected to each other may be led out to the other side surface of the body 100 to be spaced apart from each other.

Meanwhile, one coil part including the first and second coils 311 and 312 and another coil part including the third and fourth coils 313 and 314 may be magnetically coupled to each other to have the coupling coefficient k.

The inner ends of the first and second coils 311 and 312 may be connected to each other through the first and second vias 321 and 322, and their outer ends may respectively be connected to first and second external electrodes 410 and 420 described below through the first and second lead portions 331 and 332.

Accordingly, a signal input to the first external electrode 410 may be output to the second external electrode 420 through the first lead portion 331, the first coil 311, the first and second vias 321 and 322, the second coil 312, and the second lead portion 332. Through this structure, the first and second coils 311 and 312 may entirely function as one coil part connected between the first and second external electrodes 410 and 420.

Similarly, the inner ends of the third and fourth coils 313 and 314 may be connected to each other through the third and fourth vias 323 and 324, and their outer ends may respectively be connected to the third and fourth external electrodes 430 and 440 described below through the third and fourth lead portions 333 and 334.

Accordingly, a signal input to the fourth external electrode 440 may be output to the third external electrode 430 through the fourth lead portion 334, the fourth coil 314, the third and fourth vias 323 and 324, the third coil 313, and the third lead portion 333. Through this structure, the fourth and third coils 314 and 313 may entirely function as another coil part connected between the fourth and third external electrodes 440 and 430.

Here, the reason why input/output directions of the third and fourth coils 313 and 314 are different from those of the first and second coils 311 and 312 is to generate negative coupling in which the coupling coefficient k has a negative value. For example, the coupling coefficient k between the first and second coils 311 and 312 and the third and fourth coils 313 and 314 may be designed to have a value of −0.5, and is not limited thereto.

Referring to FIG. 5, all of the first and second coils 311 and 312 and all of the third and fourth coils 313 and 314 may be magnetically coupled to each other to form a coupled magnetic flux MF, and the coupling coefficient k may be controlled based on a gap G between the second coil 312 and the third coil 313.

That is, the inductance in the coupled inductor may be determined by an interaction between the magnetic fields respectively formed by two coils magnetically coupled to each other. In this exemplary embodiment, the magnetic flux passing between the gap G may have an increased density when the gap G between the second coil 312 and the third coil 313 is increased. Therefore, a proportion of uncoupled self-inductance may be increased to make the coupling coefficient k smaller.

In the coil component 1000 according to this exemplary embodiment, the core 110 may have the larger area by having the smaller line width LW2 of each innermost turn of the first to fourth coils 311, 312, 313, and 314, thereby improving the inductance characteristic. In addition, the path of the coupled magnetic flux MF may be shorten to thus make the gap G between the second coil 312 and the third coil 313 grater as much as the path made shorten, and the coupling coefficient k may thus be designed more freely.

Referring to FIG. 5, the core 110 may have the greater length L1 by making the line width of each innermost turn of the first to fourth coils 311, 312, 313, and 314 smaller in the parallel connection section when based on the L-T cross-section along line I-I′ of FIG. 1 to show the first and second vias 321 and 322 of this exemplary embodiment. Here, the core 110 at the center of the first support member 210 is shown to have a smaller length on the L-T cross-section because a via pad region for the connection reliability is disposed on each of the upper and lower surfaces of the first and second vias 321 and 322. However, except for the via pad region, the core 110 may have substantially the same length L1 as that of the core 110 at the center of the second support member 220. Here, being substantially the same indicates being the same, including the process error, the position deviation, or the measurement error that occurs in the manufacturing process.

Referring to FIG. 6, the core 110 may have the greater length L1 by making the line width of each innermost turn of the first to fourth coils 311, 312, 313, and 314 smaller in the parallel connection section when based on the L-T cross-section along line II-II′ of FIG. 1 to show the third and fourth vias 323 and 324 of this exemplary embodiment. Here, the core 110 at a center of the second support member 220 is shown to have a smaller length on the L-T cross-section because a via pad region for the connection reliability is disposed on each of the upper and lower surfaces of the third and fourth vias 323 and 324. However, except for the via pad region, the core 110 may have substantially the same length L1 as that of the core 110 at the center of the first support member 210. Here, being substantially the same indicates being the same, including the process error, the position deviation, or the measurement error that occurs in the manufacturing process.

Referring to FIG. 7, the core 110 may have the greater width W1 by having the smaller line width LW2 of each innermost turn of the first to fourth coils 311, 312, 313, and 314 in the parallel connection section when based on the W-T cross-section along line III-III′ of FIG. 1. In addition, compared to the case where the line width LW1 of each of the first to fourth coils 311, 312, 313, and 314 is constant, the coil component 1000 according to this exemplary embodiment may have mitigated misalignment of the regions of the core 110 between one coil part including the first and second coils 311 and 312 and the other coil part including the third and fourth coils 313 and 314, and thus have the shorter path of the coupled magnetic flux.

At least one of the first to fourth coils 311, 312, 313, and 314, the first to fourth vias 321, 322, 323, and 324, and the first to fourth lead portions 331, 332, 333, and 334 may include at least one conductive layer.

For example, the first coil 311, the first and second vias 321 and 322, and the first lead portion 331 may be plated on the upper surface of the first support member 210 (based on the directions shown in FIG. 1). In this case, each of the first coil 311, the first and second vias 321 and 322, and the first lead portion 331 may include a seed layer and an electroplating layer. The seed layer may be formed by a vapor deposition method such as electroless plating or sputtering. Each of the seed layer and the electroplating layer may have a single-layer structure or a multilayer structure. The electroplating layer having the multilayer structure may be a conformal film in which another electroplating layer covers one electroplating layer, or may be a layer in which another electroplating layer is laminated on only one surface of one electroplating layer. The seed layers of the first coil 311, the first and second vias 321 and 322, and the first lead portion 331 may be integrally formed for no boundary to be formed therebetween, and are not limited thereto. The electroplating layers of the first coil 311, the first and second vias 321 and 322, and the first lead portion 331 may be integrally formed for no boundary to be formed therebetween, and are not limited thereto.

Each of the first to fourth coils 311, 312, 313, and 314, the first to fourth vias 321, 322, 323, and 324, and the first to fourth lead portions 332, 334, 343, and 334 may include a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, and is not limited thereto.

The first to fourth external electrodes 410, 420, 430, and 440 may be disposed on one surface of the body 100 (i.e., lower surface of the body 100 based on the directions shown in FIG. 1) while being spaced apart from each other, the first and second external electrodes 410 and 420 may extend to one side surface of the body 100 to respectively be connected to the first and second lead portions 331 and 332, and the third and fourth external electrodes 430 and 440 may extend to the other side surface of the body 100 to respectively be connected to the third and fourth lead portions 333 and 334.

Referring to FIGS. 1 and 3, the first external electrode 410 may be disposed on one surface (or the lower surface) of the body 100 and extend to one side surface (or the third surface) to be in contact with the first lead portion 331. The second external electrode 420 may be disposed on one surface (or the lower surface) of the body 100 and extend to one side surface (or the third surface) to be in contact with the second lead portion 332.

In addition, the third external electrode 430 may be disposed on one surface (or the lower surface) of the body 100 and extend to the other side surface (or the fourth surface) to be in contact with the third lead portion 333. In addition, the fourth external electrode 440 may be disposed on one surface (or the lower surface) of the body 100 and extend to the other side surface (or the fourth surface) to be in contact with the fourth lead portion 334.

The first to fourth external electrodes 410, 420, 430, and 440 may electrically connect the coil component 1000 to a printed circuit board or the like when the coil component 1000 according to this exemplary embodiment is mounted on the printed circuit board or the like. For example, each of the first to fourth external electrodes 410, 420, 430, and 440 disposed on one surface of the body 100 while being spaced apart from one another and a connection part of the printed circuit board may be electrically connected to each other.

Each of the first to fourth external electrodes 410, 420, 430, and 440 may be made of the conductive material such as copper (Cu), aluminum (Al), silver (Ag), tin (Sn), gold (Au), nickel (Ni), lead (Pb), chromium (Cr), titanium (Ti) or an alloy thereof, and is not limited thereto.

Each of the first to fourth external electrodes 410, 420, 430, and 440 may include a plurality of layers. For example, each of the first to fourth external electrodes 410, 420, 430, and 440 may include a first layer in contact with the first to fourth lead portions 332, 334, 343, and 334 and a second layer disposed on the first layer. Here, the first layer may be a conductive resin layer including conductive powder particles including at least one of copper (Cu) and silver (Ag) and insulating resin, or may be a copper (Cu) plating layer. The second layer may have a double layer structure of a nickel (Ni) plating layer and/or a tin (Sn) plating layer.

Referring to FIGS. 5 through 7, an insulating film IF may be disposed between the first to fourth coils 311, 312, 313, and 314 and the body 100 to cover the first to fourth coils 311, 312, 313, and 314. The insulating film IF may be formed along the surfaces of the first and second support members 210 and 220 and the first to fourth coils 311, 312, 313, and 314. The insulating film IF may be used for insulating the first to fourth coils 311, 312, 313, and 314 from the body 100, and include a well-known insulating material such as parylene. However, the present disclosure is not limited thereto. The insulating film IF may be formed by the vapor deposition method or the like, is not limited thereto, and may be formed by laminating insulating films on both the surfaces of each of the first and second support members 210 and 220.

Meanwhile, the coil component 1000 according to this exemplary embodiment may further include an insulating layer disposed in a region other than the regions where the first to fourth external electrodes 410, 420, 430, and 440 are disposed while covering an outer surface of the body 100.

The insulating layer may be formed, for example, by coating and curing an insulating material including the insulating resin on the surface of the body 100. In this case, the insulating layer may include at least one of thermoplastic resin such as polystyrene-based resin, vinyl acetate-based resin, polyester-based resin, polyethylene-based resin, polypropylene-based resin, polyamide-based resin, rubber-based resin, acrylic-based resin, thermosetting resin such as phenol-based resin, epoxy-based resin, urethane-based resin, melamine-based resin, and alkyd-based resin, and the photosensitive insulating resin.

### Second Exemplary Embodiment

FIG. 8 is a view schematically illustrating an L-T cross-section of a coil component 2000 according to a second exemplary embodiment of the present disclosure, and is a view corresponding to FIG. 5.

When comparing FIG. 8 with FIG. 5, this exemplary embodiment is different from a first exemplary embodiment in a support member 200 disposed between the first to fourth coils 311, 312, 313, and 314.

Therefore, in describing this exemplary embodiment, the support member 200 disposed between the first to fourth coils 311, 312, 313, and 314, which is different from the configuration in a first exemplary embodiment of the present disclosure, is only described, and the descriptions of the other components in a first exemplary embodiment of the present disclosure may be equally applied to descriptions of those in this exemplary embodiment.

Referring to FIG. 8, in the coil component 2000 according to this exemplary embodiment, the insulating film IF may be disposed between the first and second coils 311 and 312 and between the third and fourth coils 313 and 314, and the support member 200 may be disposed between the second and third coils 312 and 313.

In this exemplary embodiment, for example, the second and third coils 312 and 313 may respectively be in contact with both surfaces of the support member 200, the insulating film IF may be disposed, and the first to fourth vias 321, 322, 323, and 324 passing through the insulating film IF may then be disposed. Next, the first coil 311 may be disposed on the second coil 312 to be connected to both the first and second vias 321 and 322, and the fourth coil 314 may be disposed on the third coil 313 to be connected to both the third and fourth vias 323 and 324.

In this exemplary embodiment, the magnetic flux flowing between the second and third coils 312 and 313 may be minimized for strengthen the magnetic coupling between one coil part including the first and second coils 311 and 312 and another coil part including the third and fourth coils 313 and 314.

In addition, only one support member 200 may be disposed to reduce the thickness (or T-direction dimension) of the coil component 2000, which is advantageous for its miniaturization.

### Third Exemplary Embodiment

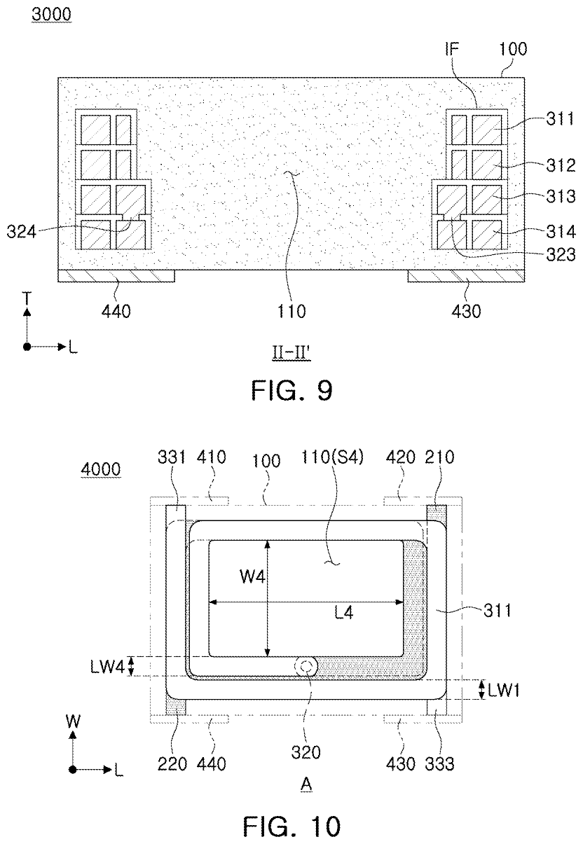

FIG. 9 is a view schematically illustrating an L-T cross-section of a coil component 3000 according to a third exemplary embodiment of the present disclosure, and is a view corresponding to FIG. 6.

When comparing FIG. 9 with FIG. 6, this exemplary embodiment is different from a first exemplary embodiment in dispositions of the first to fourth coils 311, 312, 313, and 314 and the insulating film IF disposed between the first to fourth coils 311, 312, 313, and 314.

Therefore, in describing this exemplary embodiment, the dispositions of the first to fourth coils 311, 312, 313, and 314 and the insulating film IF disposed between the first to fourth coils 311, 312, 313, and 314, which are different from the configurations in a first exemplary embodiment of the present disclosure, are only described, and the descriptions of the other components in a first exemplary embodiment of the present disclosure may be equally applied to descriptions of those in this exemplary embodiment.

Referring to FIG. 9, the coil component 3000 according to this exemplary embodiment may include the insulating film IF disposed between the first and second coils 311 and 312, between the second and third coils 312 and 313, and between the third and fourth coils 313 and 314, without the support member.

This exemplary embodiment may be implemented, for example, by disposing the fourth coil 314 to the first coil 311 as multilayers on the support member such as a copper clad laminate (CCL) board by using a build-up method and then removing the CCL board. However, the present disclosure is not limited thereto.

The insulating film IF may be disposed after disposing the fourth coil 314, and the third coil 313 may be disposed thereon after disposing the third and fourth vias 323 and 324 that pass through the insulating film IF, thereby forming the parallel pattern section between the third and fourth vias 323 and 324. In addition, as in a first exemplary embodiment, the line width of each of the third and fourth coils 313 and 314 in the parallel pattern section may be made smaller than the other section.

Next, the insulating film IF may be disposed on the third coil 313, and the second coil 312 may then be disposed thereon without via connection.

Next, the insulating film IF may be disposed on the second coil 312, and the first coil 311 may be disposed thereon after disposing the first and second vias 321 and 322 that pass through the insulating film IF, thereby forming the parallel pattern section between the first and second vias 321 and 322. In addition, as in a first exemplary embodiment, the line width of each of the first and second coils 311 and 312 in the parallel pattern section may be made smaller than the other section.

This exemplary embodiment may include the insulating film IF disposed between the first to fourth coils 311, 312, 313, and 314 without the support member, which may be advantageous for the coil component 3000 to be thinned.

In addition, the gap of each of the first to fourth coils 311, 312, 313, and 314 may be adjusted by controlling a thickness of the insulating film IF, and the coupling coefficient k may thus be designed more freely.

### Comparative Example and Effect

FIG. 10 is a plan view of a coil component 4000 according to a comparative example for comparison with the exemplary embodiments of the present disclosure, and is a view corresponding to FIG. 3.

When comparing FIG. 10 with FIG. 3, this exemplary embodiment is different from a first exemplary embodiment in a line width LW4 of the innermost turn of the first coil 311, a disposition of the via 320, and the corresponding length L4, width W4, area S4, or the like of the core 110.

Therefore, the description describes an effect of the present disclosure focusing on the line width LW4 of the innermost turn of the first coil 311, the disposition of the via 320, and the corresponding length L4, width W4, area S4, or the like of the core 110.

Referring to FIG. 10, the coil component 4000 according to the comparative example may include only one via 320 disposed at the end of the innermost turn of the first coil 311. In addition, the via 320 may be disposed in a central region of the first coil 311 in the length (L) direction rather than in one corner region of the first coil 311 in order for the first coil 311 to have the same number of turns as the corresponding second coil 312.

The coil component 4000 according to the comparative example may include no parallel connection section. Therefore, the line width LW4 of the innermost turn is required to be substantially the same as the line width LW1 of the other turns to maintain the R_{dc}. Accordingly, the core 110 may have the smaller length L4, width W4, and area S4 than those of an inventive example to lower the inductance characteristic and the saturation current (Iₛₐₜ) characteristic.

In addition, when projecting the innermost turns of the first and second coils 311 and 312 in the thickness (T) direction, their overlapping region may be smaller. Therefore, the first support member 210 may have a remaining area larger in an inner region of the first coil 311, the area S4 of the core 110 may also be smaller as much as the remaining area made larger, and the coupled magnetic flux may thus have a longer path.

The inventors of the inventive example simulate two types of coil components 1000 and 4000 to find out an effect of the coil component 1000 according to a first exemplary embodiment of the present disclosure, compared to that of the coil component 4000 according to the comparative example. Here, the coil component has a size of 2520, that is, a length of 2.5 mm in the L direction, a width of 2.0 mm in the W direction, and a thickness of 1.2 mm in the T direction; and the measured characteristics of the coil component are the line width LW, inductance characteristic Lₛ, DC resistance characteristics R_{dc}, and saturation current characteristic Iₛₐₜ of the coil.

As shown in Table 1 below, the parallel connection section is formed and the line width LW of the coil in the corresponding section is reduced from 150 μm to 75 μm as in the coil component 1000 according to a first exemplary embodiment of the present disclosure. In this case, it may be confirmed that Lₛ is improved by about 4.94% and Iₛₐₜ is improved by about 4.31% while the R_{dc} is insignificantly increased by 1.34%.

TABLE 1

| | Coil component 4000 | Coil component 1000 | |
|---|---|---|---|
| | of comparative | of first exemplary | Change |
| Item | example | embodiment | rate (%) |
| LW (μm) | 150 | 75 | — |
| Lₛ (nH) | 172.1 | 180.6 | +4.94 |
| Iₛₐₜ (A) | 6.357 | 6.631 | +4.31 |
| R_{dc} (mΩ) | 15.67 | 15.88 | +1.34 |

As set forth above, according to one aspect of the present disclosure, it is possible to provide the coil component with the improved inductance characteristic and saturation current (Iₛₐₜ) characteristic by securing the larger area of the central core of the coil.

According to another aspect of the present disclosure, it is possible to provide the coil component in which the direct current (DC) resistance R_{dc} may be maintained even with the reduced line width of the innermost turn.

According to another aspect of the present disclosure, it is possible to provide the coil component with the improved inductance characteristic by mitigating the misalignment of the magnetic paths between the two coils magnetically coupled to each other in the coupled inductor.

While the exemplary embodiments have been shown and described above, it will be apparent to those skilled in the art that modifications and variations could be made without departing from the scope of the present disclosure as defined by the appended claims.

What is claimed is:

1. A coil component comprising:
a body;
first and second support members disposed in the body;
first and second coils disposed on the first support member and respectively having at least one turn;
first and second vias connecting innermost turns of the first and second coils to each other;
third and fourth coils disposed on the second support member and respectively having at least one turn;
third and fourth vias connecting innermost turns of the third and fourth coils to each other; and
first to fourth external electrodes disposed on the body and respectively connected to the first to fourth coils,
wherein each of the innermost turns of the first and second coils has a parallel connection section between a point connected to the first via and a point connected to the second via, each of the innermost turns of the third and fourth coils has a parallel connection section between a point connected to the third via and a point connected to the fourth via, and
a line width of each of the innermost turns of the first to fourth coils in the parallel connection section is smaller than a line width of each adjacent outer turns.

2. The coil component of claim 1, wherein the line width of each of the innermost turns of the first to fourth coils in the parallel connection section is smaller than a line width of each of the innermost turns in the other section except the parallel connection section.

3. The coil component of claim 2, wherein the line width of each of the innermost turns of the first to fourth coils in the parallel connection section is half or less of the line width of each of the adjacent outer turns.

4. The coil component of claim 1, wherein the first and second coils connected to each other through the first and second vias are spaced apart from and magnetically coupled to the third and fourth coils connected to each other through the third and fourth vias.

5. The coil component of claim 1, wherein the body includes a core passing through the first to fourth coils and the first and second support members, and
the first to fourth coils share the core disposed in a center of the first and second support members.

6. The coil component of claim 5, wherein the first and second support members respectively include first and second through-holes in each of which the core is disposed.

7. The coil component of claim 1, wherein the body includes one surface, and one side surface and the other side surface opposing each other and connected to the one surface,
the first to fourth coils include first to fourth lead portions extending to the surfaces of the body to respectively be in contact with the first to fourth external electrodes,
the first and second lead portions extend to the one side surface of the body while being spaced apart from each other, and
the third and fourth lead portions extend to the other side surface of the body while being spaced apart from each other.

8. The coil component of claim 7, wherein the first to fourth external electrodes are disposed on the one surface of the body while being spaced apart from one another,
the first and second external electrodes extend to the one side surface of the body to respectively be connected to the first and second lead portions, and
the third and fourth external electrodes extend to the other side surface of the body to respectively be connected to the third and fourth lead portions.

9. The coil component of claim 1, wherein the first and second vias pass through the first support member, and
the third and fourth vias pass through the second support member.

10. The coil component of claim 1, wherein each diameter of the first to fourth vias is greater than the line width of each of the innermost turns of the first to fourth coils in the parallel connection section.

11. The coil component of claim 1, wherein each of the first to fourth coils has a shape of a square spiral wound parallel to a surface of the body.

12. The coil component of claim 11, wherein each of the first to fourth vias is connected to one corner region of each of the innermost turns of the first to fourth coils.

13. A coil component comprising:
a body;
first to fourth coils disposed in the body and respectively having at least one turn;
an insulating film covering the first to fourth coils;
first and second vias connecting innermost turns of the first and second coils to each other;
third and fourth vias connecting innermost turns of the third and fourth coils to each other; and
first to fourth external electrodes disposed on the body and respectively connected to the first to fourth coils,
wherein each of the innermost turns of the first and second coils has a parallel connection section between a point connected to the first via and a point connected to the second via, each of the innermost turns of the third and fourth coils has a parallel connection section between a point connected to the third via and a point connected to the fourth via, and
a line width of each of the innermost turns of the first to fourth coils in the parallel connection section is smaller than a line width of each adjacent outer turn.

14. The coil component of claim 13, wherein each of the first to fourth vias passes through the insulating film.

15. The coil component of claim 13, further comprising a support member disposed between the second coil and the third coil,
wherein the second and third coils are respectively in contact with both surfaces of the support member.

16. The coil component of claim 13, wherein the line width of each of the innermost turns of the first to fourth coils in the parallel connection section is smaller than a line width of each of the innermost turns in the other section except the parallel connection section.

17. The coil component of claim 13, wherein the first and second coils connected to each other through the first via are spaced apart from and magnetically coupled to the third and fourth coils connected to each other through the third via.

18. The coil component of claim 13, wherein at least one of first to fourth coils includes at least a portion of an outermost turn and at least a portion of the innermost turn both overlapping at least one of the first to fourth external electrodes along a thickness direction of the coil component.

19. A coil component comprising:
a body;
first and second support members disposed in the body;
first and second coils disposed on the first support member and respectively having at least one turn;
first and second vias connecting innermost turns of the first and second coils to each other;
third and fourth coils disposed on the second support member and respectively having at least one turn;
third and fourth vias connecting innermost turns of the third and fourth coils to each other; and
first to fourth external electrodes disposed on the body and respectively connected to the first to fourth coils,
wherein each of the innermost turns of the first and second coils has a parallel connection section between a point connected to the first via and a point connected to the second via, and
at least one of first and second coils includes at least a portion of an outermost turn and at least a portion of the innermost turn both overlapping at least one of the first and second external electrodes along a thickness direction of the coil component.

20. The coil component of claim 19, wherein a line width of each of the innermost turns of the first to fourth coils in the parallel connection section is smaller than a line width of each adjacent outer turns.

21. The coil component of claim 20, wherein the line width of each of the innermost turns of the first to fourth coils in the parallel connection section is smaller than a line width of each of the innermost turns in the other section except the parallel connection section.

22. The coil component of claim 20, wherein the line width of each of the innermost turns of the first to fourth coils in the parallel connection section is half or less of the line width of each of the adjacent outer turns.
